(19) United States
(12) Patent Application Publication
(10) Pub. No.: US 2025/0307121 A1
(43) Pub. Date: Oct. 2, 2025

(54) API TESTING FOR MULTI-TENANT SOFTWARE-AS-A-SERVICE

(71) Applicant: SAP SE, Walldorf (DE)

(72) Inventors: Tushar Desai, Fremont, CA (US); Zhengjun Song, Shanghai (CN)

(21) Appl. No.: 18/624,614

(22) Filed: Apr. 2, 2024

(51) Int. Cl. G06F 11/36; G06N 20/00

(52) U.S. Cl. CPC G06F 11/3684; G06F 11/3688; G06N 20/00

(57) ABSTRACT

In an example embodiment, a singular test is used to validate a user entity data model for any type of instance in an efficient manner. This results in an Entity-Agnostic test. This approach provides tremendous savings from test implementation, support, data storage, and test triaging perspective, as well as being able to always validate the functional correctness of the data model for any customer/user.

### TECHNICAL FIELD

This document generally relates to computer systems. More specifically, this document relates to Application Program Interface (API) testing for multi-tenant software-as-a-service.

### BACKGROUND

In the enterprise software domain, more and more applications are moving from on-premises to the cloud, and specifically to Software-as-a-Service (SaaS). SaaS is defined as software that is owned, delivered and managed remotely by one or more providers. The one or more providers deliver an application based on a single set of common code and data definitions, which are consumed in a one-to-many model by all contracted customers at any time and on a pay-for-use basis or as a subscription-based usage metric.

### BRIEF DESCRIPTION OF DRAWINGS

The present disclosure is illustrated by way of example and not limitation in the figures of the accompanying drawings, in which like references indicate similar elements.

FIG. 1 depicts a block diagram of an example software testing architecture.

FIG. 2 is a block diagram illustrating a system for dynamically generating test cases for APIs, in accordance with example embodiment.

FIG. 3 depicts a block diagram of a software testing architecture, in accordance with an example embodiment.

FIG. 4 is a flowchart of an example method for testing an instance of a computer software component.

FIG. 5 is a block diagram illustrating an architecture of software, which can be installed on any one or more of the devices described above.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Unlike traditional on-premises software applications, cloud applications need to support multi-tenant architectures to allow customers to build different configurations and customizations to meet their respective entities' specific requirements. The flexibility provided by the configuration and customization aspects also leads to technical challenges, specifically when it comes to testing cloud product features. Application Program Interface (API) testing is used by engineers to test one or more entity-specific instance(s) in their respective Dev/Test environments. The instance(s) used here correlate specifically to the underlying test data. Thus, the API test is unable to run successfully across multiple instances since it is usually tied heavily to the specific test data of a single entity, which is, in turn, related to a specific test instance.

Thus, for example, a software component may have four related instances, as follows:
1. Dev Instance:
Standard User entity data model has only 2 properties:
a) Username: String, Required=true
b) Email: String, Required=true
2. QA Instance A:
Developer customized User entity has one new required property and one new
optional property:
a) Username: String, Required=true
b) Email: String, Required=true
c) Age: Int, Required=false
d) Phone: String, Required=true
3. Customer Instance B:
Customer B customized User entity and added two other properties:
a) Username: String, Required=true
b) Email: String, Required=true
c) Time zone: String, Required=true
d) Phone: String, format=xxx-xxxx, Required=true
4. Customer Instance C:
Customer C customized User entity by removing/hiding email property and
adding two other
properties:
a) Username: String, Required=true
b) Email: String, required=true (Removed/hidden)
c) Gender: String, Required=true
d) Location: String, max length=100, Required=true

Here, there may have been two test cases written by an engineer. Each test case includes an indication of any mandatory or optional fields to be contained in the test data, but as will be described later the actual values for those fields may be dynamically generated later. The first may be based on the Dev instance and may have test data that recognizes the requirement for two properties or data fields (e.g. username and email) The second may be based on QA instance A, and may have test data that includes the “required” properties (username and email) and also the customized properties (age and phone).

The first test case can be run correctly on the Dev Instance and the second test case can be run correctly on the QA Instance A, but customers B and C both have their own customized user entities according to their own requirements, as specified in customer instance B and customer instance C that each have a different set of properties from those listed in Dev Instance and QA Instance A. If customer B and/or customer C attempt to run the API test cases, both will fail due to data format issues (specifically missing properties and/or related errors). Not only will having different property sets between different instances cause errors, but also the lack of having test values associated with those different properties create errors in testing.

The root cause of this is that the API tests are specifically designed to test only a few instances, and do not cover many other instances, especially where those other instances include complex configurations and/or customization aspects, such as customer instance B and customer instance C, as described above. This results in the customers running into many technical issues when using an incompatible test, causing them to file customer support cases, that developers are unable to comprehend and offer corrections due to the limited API testing on limited instances.

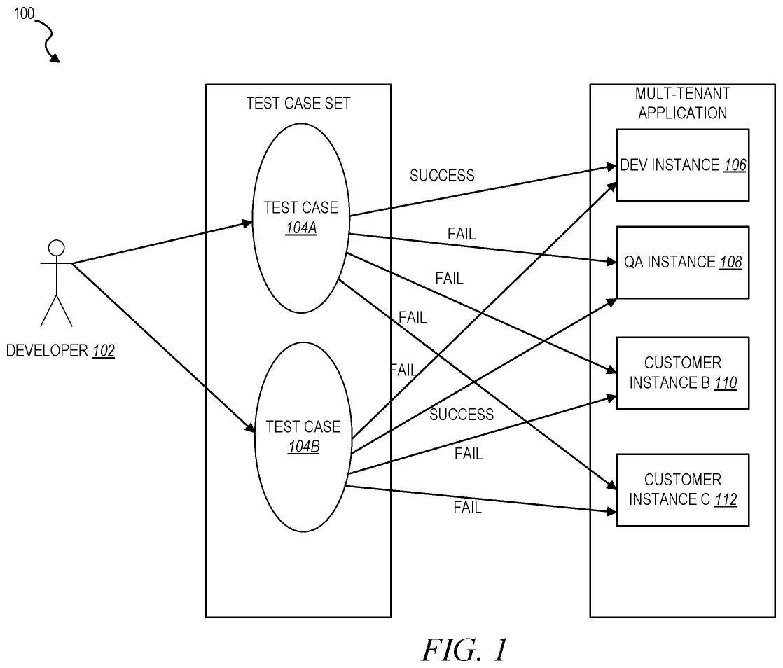

FIG. 1 depicts a block diagram of an example software testing architecture 100. This figure depicts the technical issues described above. Specifically, a developer 102 creates test case 104A and test case 104B. Test case 104A, however, is only able to successfully test Dev instance 106, while test case 104B is only able to successfully test QA instance A 108. Neither test case 104A nor test case 104B is able to successfully test customer instance B 110 or customer instance C 112.

In order to deliver a high-quality API that can meet multiple tenants' or customers' needs, it is important to use test a myriad of instances, but developing specific test cases for each instance is both resource and time intensive.

In an example embodiment, a singular test is created that can be used to validate a data model for any type of instance for a plurality of tenants in an efficient manner. This results in an Entity-Agnostic test. This approach provides tremendous savings from test implementation, support, data storage, and test triaging perspective, as well as being able to always validate the functional correctness of any data model for any customer/user.

More specifically, in an example embodiment, API test data is generated dynamically using API metadata and optionally test seed data for specific instances. The dynamically generated test data can subsequently be used for API testing of the data model on any specified instance.

In an example embodiment, the OData protocol is utilized. OData is a standardized protocol for creating and consuming data APIs. OData also provides a standard for representing API metadata to describe a data model structure. Nevertheless, the presently described solution is not limited to environments where the OData protocol is used and nothing in this disclosure shall be taken as requiring OData usage unless explicitly claimed.

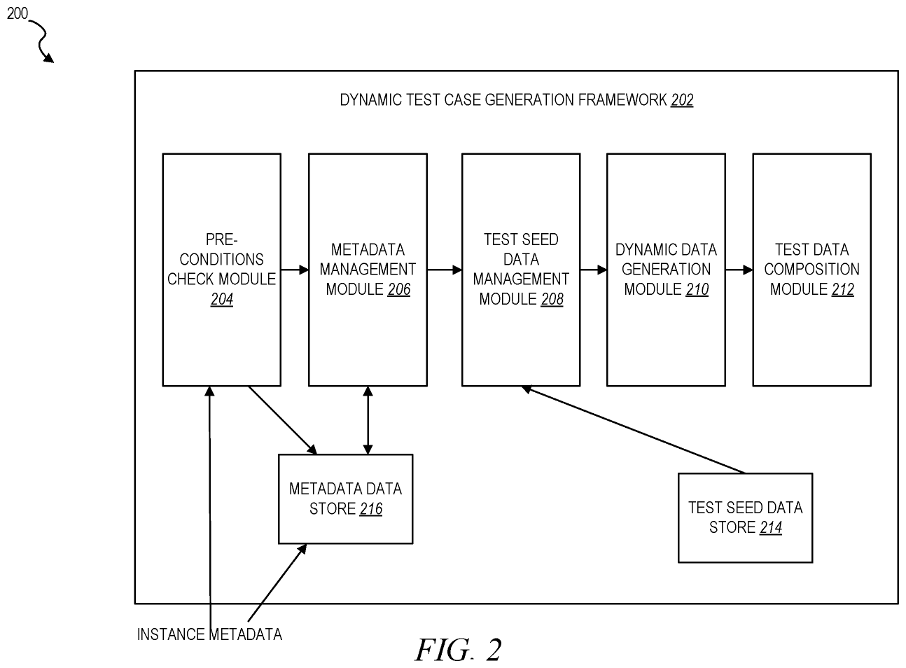

FIG. 2 is a block diagram illustrating a system 200 for dynamically generating test cases for APIs, in accordance with example embodiment. The system 200 includes a dynamic test case generation framework 202, which itself includes a pre-conditions check module 204, a metadata management module 206, a test seed data management module 208, a dynamic data generation module 210, and a test data composition module 212. Also included in the dynamic test generation framework 202 are a test seed data store 214 and a metadata data store 216.

The pre-conditions check module 204 checks if the test feature/API/entity is provisioned for in the particular instance associated with a tenant or group of tenants. Here, for example, the particular instance may contain a flag that, if set, indicates that test cases can be automatically generated for it. This allows the customer to have control over whether their instance can be tested using generated test case from the dynamic test case generation framework 202. If that flag is not set, then the other modules in the dynamic test case generation framework 202 are not invoked and a test case is not generated for the particular instance by framework 202 but instead can be provided by the tenant who has customized the underlying feature, API or entity. If the flag is set, however, the other modules in the dynamic test case generation framework 202 can be invoked.

The pre-conditions check module 204 reads data model metadata for a specified instance. This metadata may be provided, for example, in OData form. The metadata management module 206 may obtain this metadata (either from pre-conditions check module 204 or from metadata data store 216) and parses it. Thus, for example, the following metadata can be provided for Customer Instance B by a developer or administrator associated with Customer B and therefore exposed to framework 202:
Customer Instance B:
a) Username: String, Required=true
b) Email: String, Required=true
c) Time zone: String, Required=true
d) Phone: String, format=xxx-xxxx, Required=true

The metadata management module 206, after parsing the metadata, controls how the metadata can be used by modules 208, 210, 212 and 214 to add or remove runtime data based on the needs of the specific instance (in this case Customer Instance B). In some implementations, the received API metadata can be stored in metadata data store 216 by where the stored metadata can be used to dynamically generate metadata for other APIs whose data model is not exposed.

In cases where the products involved do not expose API metadata, the pre-conditions check module 204 and/or the metadata management module 206 may query or access a metadata store 216 that stores pre-configured API metadata (such as generic API metadata or API metadata from other APIs that may be determined to be similar to the API under tes) t. Metadata stores can also be used to cache metadata from exposed API metadata from other interfaces to improve performance and/or to assist in building a test scenario for an API that does not expose its metadata.

The test seed management module 208 manages test seed data. Test seed data is data that is specific to an instance and can be used to generate runtime test data rather than using fixed value properties provided by the API development team. The availability of test seed data is optional. If there is no test seed data, the framework will generate dynamic test data according to the API metadata alone. Another possibility is that there is some test seed data for a particular instance, but not enough to generate values for all the properties of that instance. In this hybrid case, the test seed data can be used to generate values for the properties it can but for any other properties the framework can generate dynamic test data according to the API metadata alone.

In some example embodiments, test seed data can be some information or policies regarding the values that will be generated for test data in addition to, or instead of, actual data values (such as example data values from historical data). For example, while API metadata may indicate that zip code may be a property of an instance (and that the zip code is a 5 digit numeric number), the seed data could indicate that the zip codes that are generated should start with a “9.”

When test seed data is provided, it can be provided at multiple different levels or scopes. In can be provided, for example, at the test case level, where the test seed data is provided for one particular test case only. Alternatively, it can be provided at the instance level, where the test seed data is provided for all test cases for a given instance. If both are present for a given test, in some example embodiments the system 200 can utilize the test seed data at that specific test level (the first type) for dynamically generating the corresponding test case.

The dynamic data generation module 210 generates dynamic test data based on the API metadata and optionally the test seed data (if provided). More particularly, the dynamic data generation module 210 obtains the API metadata from the pre-conditions check module 204 if exposed or metadata management module if not exposed and optionally the test seed data from the test seed management module 208. Newly generated runtime data can be randomized to prevent data collisions.

In an example embodiment, the test seed data management module 208 may follow the following process:
1. Generate dynamic test data based on test seed data (such as golden data, which are values actually used previously in the system) I.
   1.1. Query specific entity data from run-time application/instance according to pre-configured test seed data unique id/name, if no pre-configured value, then use a default value (e.g., Rest API call or Query from DB table, depending on implementation).
   1.2. Query API entity metadata from pre-conditions check module 204, then decide which properties values can be re-usable from specific/golden entity data. A series of rules are defined to perform a condition check (e.g., fixed rules or use of a rule engine to parse dynamic rules which support configure rules dynamically, depending upon implementation). For example, Rule #1: if property requires a unique value, then the value is not re-useable, Rule #2: if property value is null or empty, then the value is not re-useable, Rule #3: if property doesn't support insert/update (usually it means the system generates a value automatically), then skip it, etc.
   1.3. Rule #1 check: If property is unique, then data from test seed data can NOT be used; if it is not unique, then check next rule.
   1.4. Rule #2 check: if its value is empty or null, then data from golden data can NOT be used; if it meets rule condition, then go to next rule.
   1.5. All rules check passed, then copy/re-use this property value directly.
2. Generate dynamic test data based on API metadata.
   2.1. Query property metadata for given entity from metadata management module 206,C e.g., data type, data format, min/max length, is unique, creatable, updatable, associated entity object (e.g., dropdown option list), default value, etc.
   2.2. If property has default value, then use default value.
   2.3. If property has association with another object (e.g., Country property associated with country option list, then query associated country option list first and choose random value or use Manager property associated with User entity) then choose a value from associated User object (Rest API call or Query from DB table, depending on implementation).
   2.4. If property has correlation relationship (e.g., dependency relationship) with another property, e.g., Country, State and City. In some examples a parent-child relationship exists. Specifically, Country-State is parent-child relationship as is State-City and for such cases, the parent's value is generated first; then according to parent's value, the child's value is generated second.
   2.5. If a property does not have an associated object, then generate a dynamic value according to data type, data format, min/max length, etc. This will be described in more detail below.
3. Pass all generated data for the given entity in Step #1 and Step #2 to test data composition module 212 to generate final test data.

In an example embodiment, the process for step 2.5 can be performed by a stand-alone service accepting property metadata to generate dynamic output. This stand-alone service can use one or more of the solutions below, alone or in combination with each other:

### Solution #1: Random Data Generation

An algorithm can be used to generate random data (random string, numbers, dates, etc.) based on property metadata.
This algorithm can include the following:
1. Parse input (property metadata).
2. Choose different generators (String Generator, Number Generator, Date Generator, etc. each data type has corresponding data generator) based on data type.
3. In each generator, perform two steps: generate random data and format data.
   Generate random data with Random library according to property metadata, e.g., length/min-max, etc. A code example for generating a random string is:
   public static String randomString (int length) {
      final SecureRandom random=new SecureRandom ( );
      char [ ] text=new char [length];
      for (int I=0; I<length; i++) {
         text [i]=
   SOURCES.charAt (random.nextInt (SOURCES.length ( ));
      }
      return new String (text)}
   {
   Format the random data generated in the above step if there is data format in property metadata. A code example is:
   public static String FormatData (String dateValue, String dateFormat) {
      SimpleDateFormat simpeDateFormat=new
      SimpleDateFormat (dastaFormat);
      String data=simpleDataFormat.format (dateValue”);
      return date;
   }

For example, the below examples showcase the inputs and output after using the above algorithm(s).
property metadata: Username: String, required=true, Unique=true, Max length=100, then according to property metadata, the String Generator generates a unique string value, “Rftd3_t23456”.
property metadata: dateOfBirth, type: Date, format: YYYY-MM-DD, then according to property metadata, the Date Generator generates a unique date value, “1980 Nov. 16”.

One can also use many other algorithms/predefined rules/open-source library to generate data.

### Solution #2: Dynamic Data Generation Based on Real Data/Test History Data.

This solution relies on real data from tested application/instance or test history data saved after successful test case execution (e.g., execution of Rest API or query database table directly). Using real data, algorithms/predefined rules can be leveraged to mask real data (e.g., use data anonymization and data masking technology for sensitive data) to make it different but consistent with the same structure and keeping it realistic. If the test data property requires uniqueness, one can generate randomized value(s) and add it into new data to make it unique.

Refer to the below example for shuffling username data:
property metadata: Username: String, required=true, Unique=true, Max length=100. Some example real data from tested instance could be: Username: “MilicaPolinger,” “MarkoDebric,” “JelenaAtlagic.” This data is input into one or more algorithms or rules, such as shuffling username, so as to generate:
“JelenaDebric” or “MarkoPolinger.”
The predefined rules can be created by a human using intuition and domain knowledge, but this takes time and effort to come up with these rules. Another way is to train an Artificial Intelligence. Machine learning (ML) model with real data/test history data as training data, then leverage this ML model to generate synthetic data (Data generated using ML-based systems is known as synthetic data) based on learned patterns from existing data sets.

The machine learning model may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning training component used to train the machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by a user providing live feedback.

Solution #3: Dynamic Data Generation with Generative Artificial Intelligence/Large Language Models (LLMs)

A large language model (LLM) refers to an artificial intelligence system that has been trained on an extensive dataset to understand and generate human language. These models are designed to process and comprehend natural language in a way that allows them to answer questions, engage in conversations, generate text, and perform various language-related tasks.

In an example embodiment, an LLM or related technology is used to generate dynamic test data. A dynamic prompt template can be defined, then according to property metadata and the template a prompt is generated for sending to an LLM to generate test data.

An example prompt template may be:
prompt Template=‘“
You are dynamic data generator; I need you help to generate data according to below requirement:
Data description: {data description}
Data type: {data type}
Data format: {data format}
Max length: {max length}
Is unique: {unique}
Ensure that the data you generated matches the above requirement and that it looks realistic.
Then the token values in the prompt template above can be replaced with property metadata such as: Username: String, required=true, Unique=true, Max length=100, to get the prompt:
You are dynamic data generator; I need you help to generate data according to below requirement:
Data description: username
Data type: String
Data format:
Max length: 100
Is unique: true.
Ensure that the data you generated matches the above requirement, also make sure the data looks realistic.
’”
We then execute Gen-AI/LLM API with prompt, here we use open ai API with gpt-3.5-turbo model,
we can get new username (it may generate different content for different LLM):
Generated Username: “TechEnthusiast23”.

LLM generation can occasionally encounter a Hallucination issue, where plausible-sounding yet false answers are generated. In order to reduce hallucination and generate accurate content, in an example embodiment retrieval-augmented-generation (RAG) technology may be used to retrieve some example data, then put that data into the prompt template as one-shot or multi-shot example prompts to provide In-Context-Learning examples to the LLM, then the LLM can generate test data based on these examples. In some example embodiments, the LLM can also leverage external tools (e.g., Function Calling) to extend its capability, e.g., call tools to generate data which match customized data type, and call tools to validate generated test data, then the LLM generates more meaningful and accurate test data. In this example embodiment, AI-Agent technology can be used to perform more complex tasks.

Agents are LLMs that are being prompted to reason about the actions needed to complete a request. An agent can choose which tool can be used from a set of tools. Some of these tools may, for example, query example data based on entity, generate test data for customized data type, validate generated test data, etc.

Agents can use a variety of strategies to make the LLM reason and decide about the actions they must take. One such strategy for agents is the ReAct method. ReAct uses few-shot learning together with Chain-of-Thought reasoning.
Thoughts transcribed from the reasoning strategies.
Actions that let the LLM interact with its environment, e.g., call external tools.
Observations gained after taking the actions.

Thus the LLM can decide to use the tool to query example data to generate a dynamic prompt with real data, and then generate test data. The following is a multi-shot example:
‘“
You are dynamic data generator; I need you help to generate data according to below requirement:
Entity name: User
Property data description: username
Property data type: String
Property data format:
Property data max length: 100
Property data is unique: true.
Also please see below example username data.
username: MilicaPolinger
username: MarkoDebric
username: JelenaAtlagic
Ensure that the data you generated matches the above requirement, also please validate generated username test data for User entity with tools to make sure it is unique.
’”
The LLM process may be iterated to generate:
Username: “SophiaMiller_1990”.
   And this looks unique and more meaningful.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLS™) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLS™, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, though a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model.

The test data composition module 212 composes the final test data for the data model entity. This final test data can be composed from any combination of:
1. Test seed data configured in the test seed management module 208
2. Test data wrote in the test case
3. Test data generated dynamically by the dynamic data generation module 210.

The test data composition module 212 may utilize the API metadata to check whether properties of the entity are required versus redundant, since some properties are unnecessary in entity metadata for particular instances and thus can be removed. For example, while there are circumstances where the test APIs created by the developer are missing some properties that are used by a particular instance to be tested (e.g., customer instance B contains a time zone property not contained in the test APIs developed for Dev instance or QA instance A), the opposite can be true as well. In other words, in some embodiments the test API created by the developer has extra properties that are not actually used by the particular instance to be tested (e.g., customer instance C does not contain the email property contained in the test APIs developed for the Dev instance and the QA instance A). The test data composition module 212 is able to recognize this fact and remove such extraneous properties from the test case(s) generated for that particular instance.

Once the final test data for the data model is composed, it can be used to execute API testing on the specified instance.

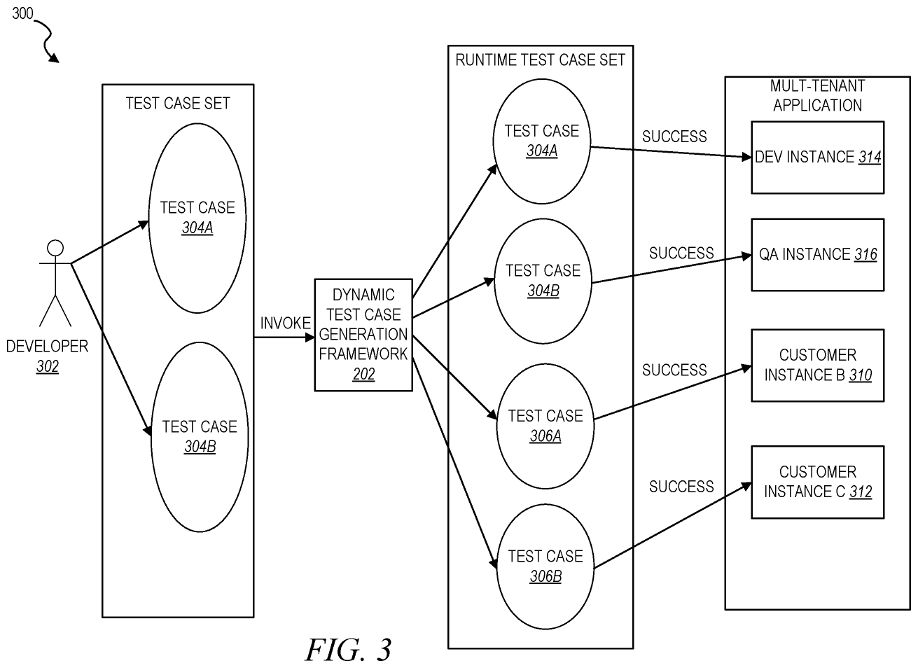

FIG. 3 depicts a block diagram of a software testing architecture 300, in accordance with an example embodiment. As with FIG. 1, a developer 302 creates test case 304A and test case 304B. Here, however, dynamic test case generation framework 202 dynamically generates new test cases 306A and 306B. Since test case 306A has been specifically designed to test customer instance B 310 and test case 306B has been specifically designed to test customer instance C 312 (as well as previously designed test cases 304A and 304B being specifically designed to test dev instance 314 and QA instance 316, respectively), this means that all instances 310-316 are successfully tested despite the developer 102 not specifically developing test cases for customer instance B 310 or customer instance C 312.

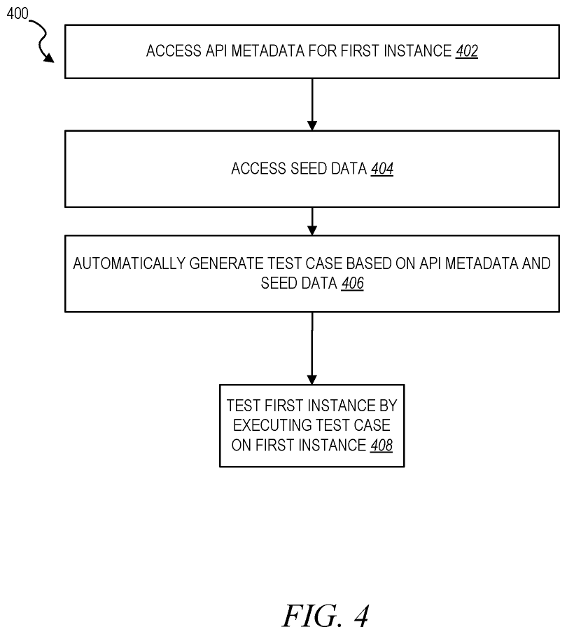

FIG. 4 is a flowchart of an example method for testing an instance of a computer software component. At operation 402, application program interface (API) metadata for a first instance of a computer software component is accessed. This API metadata may be in, for example, OData format. In many cases this API metadata will be obtained via exposed A {I metadata. In some example embodiments, however, this API metadata is preconfigured and stored in a metadata data store. At operation 404, seed data may optionally be accessed as well. The seed data may be specified at, for example, the API test case level or at the entity (e.g., customer) level. At operation 406, an API test case is automatically generated based on the API metadata and (optionally) the seed data. This API test case can be generated in a number of different ways. In one example embodiment, a machine learning model is trained using test history data as training data. In another example embodiment, a dynamic prompt template is combined with the API data to generate a prompt that is sent to an LLM to generate code for the API test case. At operation 408, the first instance of the computer software component is tested by executing the API test case on the first instance of the computer software component.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: accessing application program interface (API) metadata for a first instance of a computer software component; dynamically generating an API test case based on the API metadata; and testing the first instance of the computer software component by executing the API test case on the first instance of the computer software component.

In Example 2, the subject matter of Example 1 includes, wherein the operations further comprise: accessing seed data; and wherein the dynamically generating includes dynamically generating an API test case based on the data model metadata and the seed data.

In Example 3, the subject matter of Example 2 includes, wherein the seed data is specified for the API test case being generated.

In Example 4, the subject matter of Examples 2-3 includes, wherein the seed data is specified for an entity for which the first instance is run.

In Example 5, the subject matter of Examples 1˜4 includes, wherein the operations further comprise: accessing test history data; and training a machine learning model using the test history data as training data, the training comprising iterating among various weights that will be multiplied by various input variables and evaluating a loss function at each iteration, until the loss function is minimized, wherein the dynamically generating the API test case includes using the trained machine learning model.

In Example 6, the subject matter of Example 5 includes, wherein the operations further comprise: dynamically retraining the machine learning model based on feedback from a user.

In Example 7, the subject matter of Examples 1-6 includes, wherein the dynamically generating the API test case includes accessing a dynamic prompt template; generating a prompt based on the dynamic prompt template and the API metadata; and feeding the prompt to a large language model (LLM) to generate code for inclusion in the API test case.

Example 8 is a method comprising: accessing application program interface (API) metadata for a first instance of a computer software component; dynamically generating an API test case based on the API metadata; and testing the first instance of the computer software component by executing the API test case on the first instance of the computer software component.

In Example 9, the subject matter of Example 8 includes, accessing seed data; and wherein the dynamically generating includes dynamically generating an API test case based on the data model metadata and the seed data.

In Example 10, the subject matter of Example 9 includes, wherein the seed data is specified for the API test case being generated.

In Example 11, the subject matter of Examples 9-10 includes, wherein the seed data is specified for an entity for which the first instance is run.

In Example 12, the subject matter of Examples 8-11 includes, accessing test history data; and training a machine learning model using the test history data as training data, the training comprising iterating among various weights that will be multiplied by various input variables and evaluating a loss function at each iteration, until the loss function is minimized, wherein the dynamically generating the API test case includes using the trained machine learning model.

In Example 13, the subject matter of Example 12 includes, dynamically retraining the machine learning model based on feedback from a user.

In Example 14, the subject matter of Examples 8-13 includes, wherein the dynamically generating the API test case includes accessing a dynamic prompt template; generating a prompt based on the dynamic prompt template and the API metadata; and feeding the prompt to a large language model (LLM) to generate code for inclusion in the API test case.

Example 15 is a non-transitory machine-readable medium storing instructions which, when executed by one or more processors, cause the one or more processors to perform operations comprising: accessing application program interface (API) metadata for a first instance of a computer software component; dynamically generating an API test case based on the API metadata; and testing the first instance of the computer software component by executing the API test case on the first instance of the computer software component.

In Example 16, the subject matter of Example 15 includes, wherein the operations further comprise: accessing seed data; and wherein the dynamically generating includes dynamically generating an API test case based on the data model metadata and the seed data.

In Example 17, the subject matter of Example 16 includes, wherein the seed data is specified for the API test case being generated.

In Example 18, the subject matter of Examples 16-17 includes, wherein the seed data is specified for an entity for which the first instance is run.

In Example 19, the subject matter of Examples 15-18 includes, wherein the operations further comprise: accessing test history data; and training a machine learning model using the test history data as training data, the training comprising iterating among various weights that will be multiplied by various input variables and evaluating a loss function at each iteration, until the loss function is minimized, wherein the dynamically generating the API test case includes using the trained machine learning model.

In Example 20, the subject matter of Example 19 includes, herein the operations further comprise: dynamically retraining the machine learning model based on feedback from a user.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

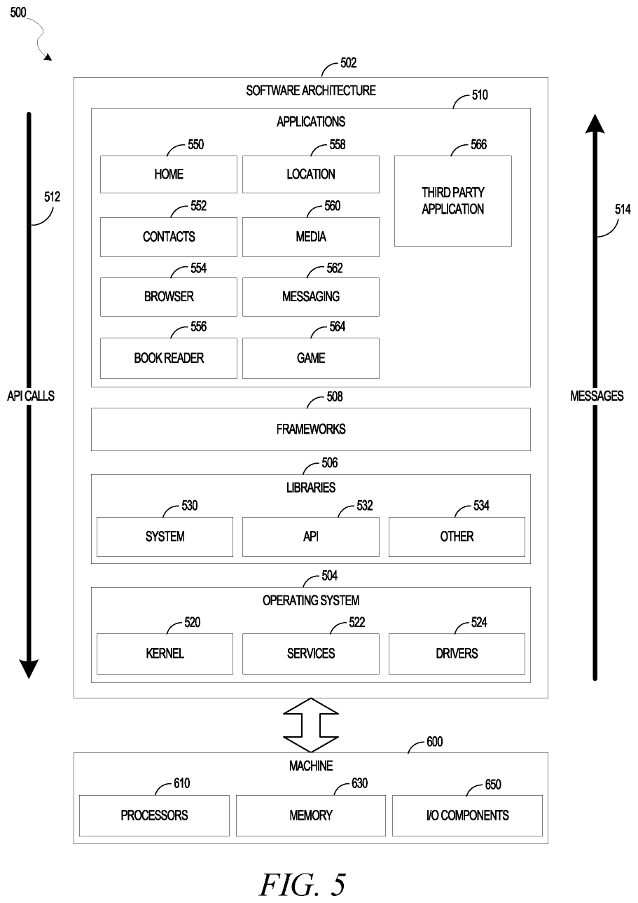

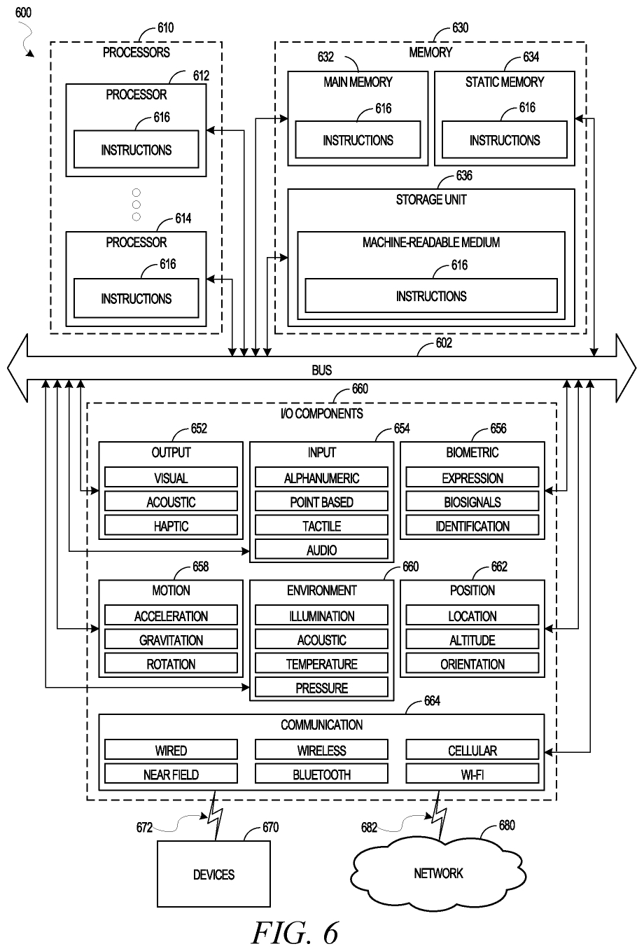

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement the systems described in FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing application program interface (API) metadata for a first instance of a computer software component;
dynamically generating an API test case based on the API metadata; and
testing the first instance of the computer software component by executing the API test case on the first instance of the computer software component.

2. The system of claim 1, wherein the operations further comprise:
accessing seed data; and
wherein the dynamically generating includes dynamically generating the API test case based on the API metadata and the seed data.

3. The system of claim 2, wherein the seed data is specified for the API test case being generated.

4. The system of claim 2, wherein the seed data is specified for an entity for which the first instance is run.

5. The system of claim 1, wherein the operations further comprise:
accessing test history data; and
training a machine learning model using the test history data as training data, the training comprising iterating among various weights that will be multiplied by various input variables and evaluating a loss function at each iteration, until the loss function is minimized, wherein the dynamically generating of the API test case includes using the trained machine learning model.

6. The system of claim 5, wherein the operations further comprise:
dynamically retraining the machine learning model based on feedback from a user.

7. The system of claim 1, wherein the dynamically generating the API test case includes
accessing a dynamic prompt template;
generating a prompt based on the dynamic prompt template and the API metadata; and
feeding the prompt to a large language model (LLM) to generate code for inclusion in the API test case.

8. A method comprising:
accessing application program interface (API) metadata for a first instance of a computer software component;
dynamically generating an API test case based on the API metadata; and
testing the first instance of the computer software component by executing the API test case on the first instance of the computer software component.

9. The method of claim 8, further comprising:
accessing seed data; and
wherein the dynamically generating includes dynamically generating the API test case based on the API metadata and the seed data.

10. The method of claim 9, wherein the seed data is specified for the API test case being generated.

11. The method of claim 9, wherein the seed data is specified for an entity for which the first instance is run.

12. The method of claim 8, further comprising:
accessing test history data; and
training a machine learning model using the test history data as training data, the training comprising iterating among various weights that will be multiplied by various input variables and evaluating a loss function at each iteration, until the loss function is minimized, wherein the dynamically generating the API test case includes using the trained machine learning model.

13. The method of claim 12, further comprising:
dynamically retraining the machine learning model based on feedback from a user.

14. The method of claim 8, wherein the dynamically generating the API test case includes
accessing a dynamic prompt template;
generating a prompt based on the dynamic prompt template and the API metadata; and
feeding the prompt to a large language model (LLM) to generate code for inclusion in the API test case.

15. A non-transitory machine-readable medium storing instructions which, when executed by one or more processors, cause the one or more processors to perform operations comprising:
accessing application program interface (API) metadata for a first instance of a computer software component;
dynamically generating an API test case based on the API metadata; and
testing the first instance of the computer software component by executing the API test case on the first instance of the computer software component.

16. The non-transitory machine-readable medium of claim 15, wherein the operations further comprise:
accessing seed data; and
wherein the dynamically generating includes dynamically generating the API test case based on the API metadata and the seed data.

17. The non-transitory machine-readable medium of claim 16, wherein the seed data is specified for the API test case being generated.

18. The non-transitory machine-readable medium of claim 16, wherein the seed data is specified for an entity for which the first instance is run.

19. The non-transitory machine-readable medium of claim 15, wherein the operations further comprise:
accessing test history data; and
training a machine learning model using the test history data as training data, the training comprising iterating among various weights that will be multiplied by various input variables and evaluating a loss function at each iteration, until the loss function is minimized, wherein the dynamically generating the API test case includes using the trained machine learning model.

20. The non-transitory machine-readable medium of claim 19, herein the operations further comprise:
dynamically retraining the machine learning model based on feedback from a user.
